(19) United States
(12) Patent Application Publication
(10) Pub. No.: US 2004/0067086 A1
(43) Pub. Date: Apr. 8, 2004

(54) Foldable keyboard

(76) Inventors: Robert Olodort, Santa Monica, CA (US); Peter M. Cazalet, Campbell, CA (US); John Tang, San Carlos, CA (US)

Correspondence Address: James C. Scheller, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/254,147

(22) Filed: Sep. 24, 2002

Related U.S. Application Data
(60) Provisional application No. 60/359,585, filed on Feb. 25, 2002.

(51) Int. Cl. B41J 5/16

(52) U.S. Cl. 400/472

(57) ABSTRACT

A foldable keyboard assembly having a first keyboard section, a second keyboard section, a linkage assembly and a support plate. The linkage assembly, in one embodiment, enables the keyboard assembly to alternate between a folded and unfolded keyboard configuration. In an unfolded configuration, the keyboard assembly has first keyboard section and second keyboard section co-planar to form a full-size keyboard. The support plate aligns under the keyboard sections. In a folded configuration, first keyboard section, second keyboard section and support plate align on top of each other.

This application is related to and claims the benefit of U.S. provisional application 60/359,585 entitled “Foldable Keyboard,” filed Feb. 25, 2002.

### FIELD OF THE INVENTION

The invention relates generally to keyboard assemblies for information devices, and more particularly to foldable keyboards for such devices.

### BACKGROUND OF THE INVENTION

Personal Digital Assistants or “PDAs” have succeeded as useful devices as electronic replacements of calendars and address books. Unlike notebook computers, PDAs are small enough to hold in the palm of one hand or fit in a pocket. They power on instantly, and are easy to use. They have touch screens and styluses, which when used with appropriate handwriting recognition or onscreen “virtual” keyboards, allow for navigation, retrieving information, or entering small amounts of text. Recent advances in processing power, memory capacity, and application software, combined with the proliferation of wireless networks, have allowed PDAs to become very useful as communication devices and replacements for notebook computers. But in order to perform adequately as an e-mail machine or a not-taking device, a PDA must allow the user to quickly and comfortably enter text. Increasingly, many mobile phones have “smart phone” capabilities. They are able to function as wireless e-mail devices. However, writing e-mail of any appreciable length using the phone's keypad is a frustrating experience.

What is needed is an accessory keyboard for PDAs, mobile phones, and other devices, that allows fast and comfortable touch-typing, yet folds to a very small size so it can be conveniently carried along with such devices.

The keyboard standard described by ISO 9241-4:1998(E) 6.2.1 calls for center-to-center key spacing (i.e., pitch) of 19 mm ±1 mm. ISO 9241-4:1998(E) 6.2.3 calls for preferred key displacement between 2.0 mm and 4.0 mm. Experience has shown that keyboards must be designed in conformance with these standards in order to allow touch-typing (typing quickly, comfortably, and accurately with one's fingers, without the need to look at the keyboard).

U.S. Pat. No. 3,940,758 describes a keyboard that folds to a smaller footprint than a full size keyboard. Yet it neither folds to a thin dimension, nor is it rigid when used on a lap. U.S. Pat. No. 5,457,453 describes a folding keyboard. Yet if this design were to be made thin, the keyboard would not be rigid unless it was placed on a hard, flat surface. U.S. Pat. No. 5,574,481 describes a foldable, adjustable keyboard. If made as a full size keyboard, its hinges would not provide rigidity when the keyboard is in use. U.S. Pat. No. 5,653,543 describes another folding keyboard that, if made to fold thin, would not be rigid when used on a lap. U.S. Pat. No. 5,703,578 describes a folding keyboard with sliding rows of keys. If made thin, this design would not be strong enough to withstand the force of typing. U.S. Pat. No. 5,941,648 describes a folding keyboard with reduced sized key pitch, a reduced travel key mechanism and a non standard layout. It has no means for rigidity when used on a lap. U.S. Pat. No. 5,943,041 is another folding keyboard, which if made thin, has no means for rigidity unless supported by a hard, flat surface. U.S. Pat. No. 6,151,012 is yet another folding keyboard that would not be rigid if made thin. These and other examples of prior art folding keyboards are illustrated in FIGS. 1A-1D.

### SUMMARY OF THE INVENTION

The present invention pertains to a foldable keyboard assembly. In one embodiment, the keyboard assembly has a first keyboard section and a second keyboard section foldable with respect to each other between a folded configuration and an unfolded configuration. In the unfolded configuration, the first and second keyboard sections may be a co-planar and a support plate may be aligned under both keyboard sections.

Additional features and advantages of the present invention will be apparent from the accompanying drawings, and from the detailed description that follows below.

### BRIEF DESCRIPTION OF THE DRAWINGS

The present invention is illustrated by way of example, and not limitation, in the figures of the accompanying drawings in which:

FIG. 1A illustrates a prior art foldable keyboard.

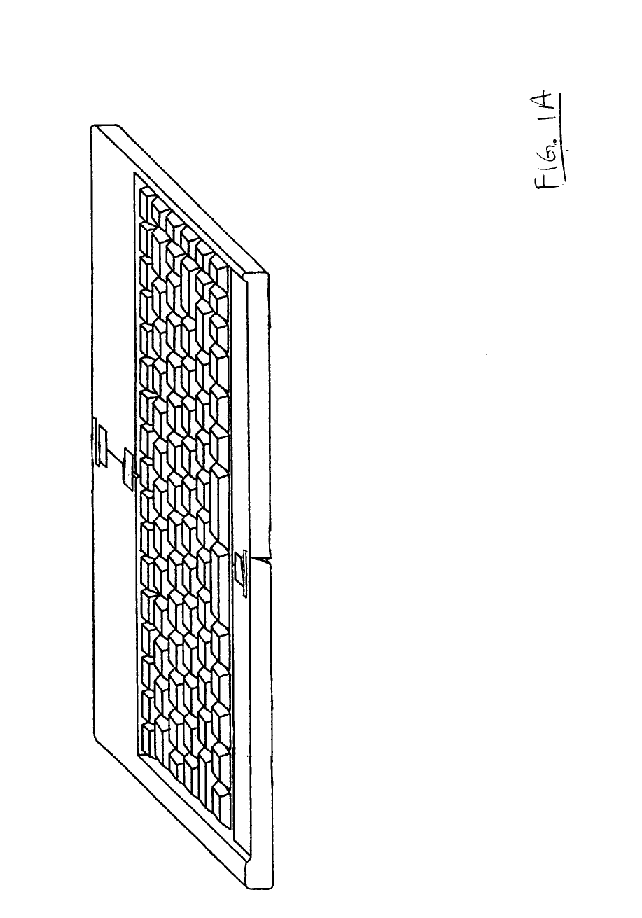

FIG. 1B illustrates a side view of a prior art foldable keyboard.

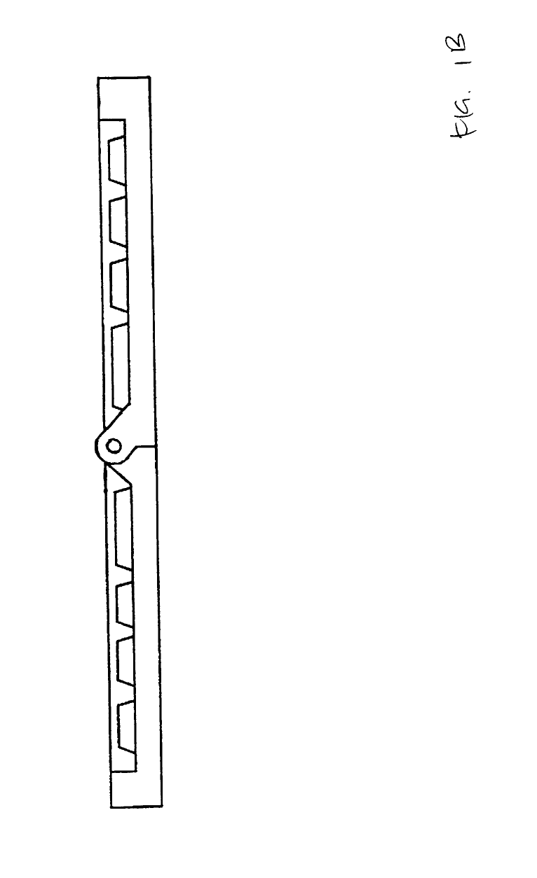

FIG. 1C illustrates another prior art foldable keyboard.

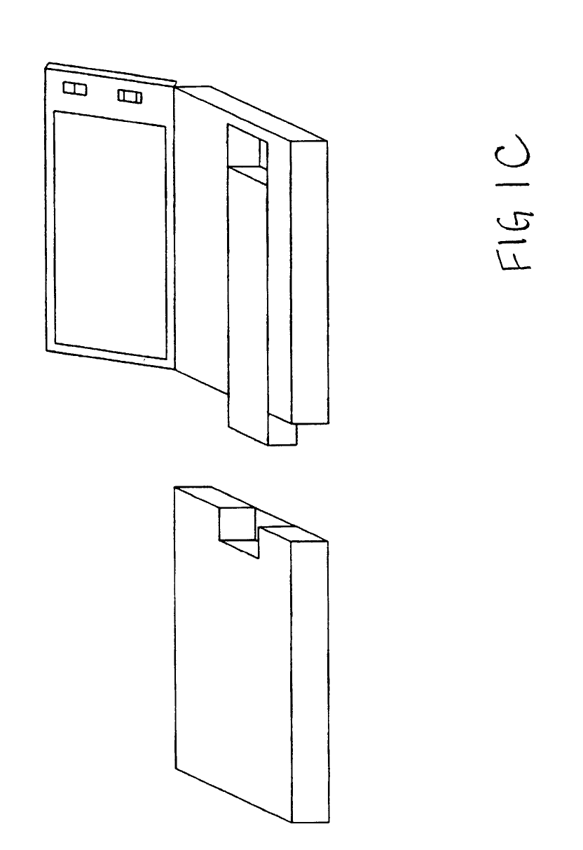

FIG. 1D illustrates another prior art foldable keyboard.

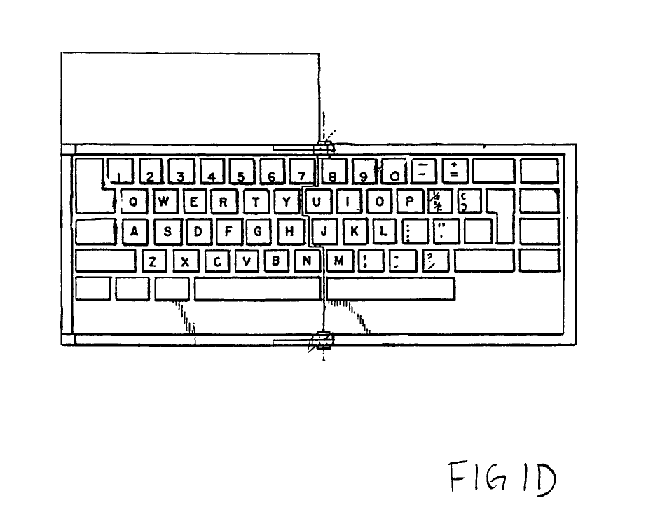

FIG. 2 illustrates one embodiment of a foldable keyboard with a digital processing device.

FIG. 2A illustrates one embodiment of a conductive strip arrangement on a foldable keyboard.

FIG. 2B illustrates another embodiment of a conductive strip arrangement on a foldable keyboard.

FIG. 3A illustrates one embodiment of a foldable keyboard in an unfolded configuration.

FIG. 3B illustrates one embodiment of a foldable keyboard in another unfolded configuration.

FIG. 3C illustrates one embodiment of a foldable keyboard in a partially unfolded configuration.

FIG. 3D illustrates one embodiment of a foldable keyboard in another partially unfolded configuration.

FIG. 3E illustrates one embodiment of a foldable keyboard in a folded configuration.

FIG. 4A illustrates in a side view one embodiment of a foldable keyboard in an unfolded configuration.

FIG. 4B illustrates in a side view one embodiment of a foldable keyboard in a partially unfolded configuration.

FIG. 4C illustrates in a side view one embodiment of a foldable keyboard in a folded configuration.

FIG. 5A illustrates one embodiment of a linkage assembly in an unfolded configuration.

FIG. 5B illustrates one embodiment of a linkage assembly in a partially unfolded configuration.

FIG. 5C illustrates one embodiment of a linkage assembly in another partially unfolded configuration.

FIG. 5D illustrates one embodiment of a linkage assembly in a folded configuration.

FIG. 6 illustrates a standard QWERTY keyboard layout.

### DETAILED DESCRIPTION

In the following description, numerous specific details are set forth such as examples of specific, components, circuits, processes, etc. in order to provide a thorough understanding of the present invention. It will be apparent, however, to one skilled in the art that these specific details need not be employed to practice the present invention. In other instances, well known components or methods have not been described in detail in order to avoid unnecessarily obscuring the present invention.

A foldable keyboard assembly having portable capabilities is described. The keyboard, when in the folded configuration, is capable of maintaining a very small and thin profile. In the unfolded configuration, the keyboard expands to a full-size QWERTY layout, in one exemplary embodiment, having a very rigid structure for ease of use on a variety of surfaces, including rigid and non-rigid surfaces, such as a person's lap.

In another embodiment of this invention, a full size keyboard folds to an extremely thin dimension, yet when in use is completely rigid, so it can be used on one's lap. In this manner, the device could be used to take notes at a lecture or to write e-mail while sitting on a chair or bench.

In one embodiment, the foldable keyboard assembly may be an input device for a personal digital assistant (“PDA”) handheld organizer, mobile phone, or other types of hand-held computing or communication devices compatible with a keyboard.

In one embodiment, the foldable keyboard assembly has a first keyboard section, a second keyboard section foldable with respect to the first keyboard section, and a support plate aligned under both keyboard sections in an unfolded keyboard configuration. The support plate maintains the key sections rigid so that a user may “touch type” comfortably without having to place the keyboard on flat, firm surface. For example, the keyboard assembly in the unfolded configuration allows a user to place the keyboard on a variety of uneven surface, such as the lap, and type effectively without the keyboard assembly collapsing.

In another embodiment, the foldable keyboard assembly has a first keyboard section, a second keyboard section, and a support plate. The keyboard sections and the support plate have substantially the same width and length. For the purpose of describing the present invention, the length is defined as the distance from the left to the right of each section or plate, such as the left edge of the left-most key to the right edge of the right-most key of each key section. The width is defined as the distance from the front to the back of each section or plate, such as the front edge of the front-most key to the back edge of the back-most key. The second keyboard section and the support plate form the exterior top and bottom surfaces of a self-contained housing for the keyboard assembly in the folded configuration. In the folded keyboard configuration, the keys of the first keyboard section and the keys of the second keyboard section oppose each other. The contact made by the keys of the keyboard sections causes the keys to fully compress, thereby minimizing the thickness of the keyboard assembly in the folded configuration.

In one embodiment, the foldable keyboard assembly has a first keyboard section, a second keyboard section foldable with respect to the first keyboard section, and a linkage assembly to couple the first keyboard section to the second keyboard section. The linkage assembly includes four bars. A first bar is coupled to the first keyboard section along a length of the first keyboard section near a region where the first keyboard section meets the second keyboard section in the unfolded configuration. A second bar is coupled to the second keyboard section along a length of the second keyboard section near a region where the second keyboard section meets the first keyboard section in the unfolded configuration.

A third bar couples the first bar to the second bar. The third bar has a first pivot coupled to the first keyboard section and a second pivot coupled to the second keyboard section. The second pivot moves along a rotating arc of the first pivot. A fourth bar also couples the first bar to the second bar. The fourth bar has a third pivot coupled to the first bar and a fourth pivot coupled to the second bar. The linkage assembly enables the keyboard sections to fold and unfold with respect to each other.

In one embodiment, the first keyboard section is coupled to the support plate such that the first keyboard section may slide along a length of the support plate. As the second keyboard section folds to align over the first keyboard section, the first keyboard section slides in a first direction along the support plate. In the folded configuration, the first keyboard section slides to align over the support plate such that both keyboard sections and the support plate form a unitary body.

Alternatively, from a folded keyboard configuration, the second keyboard section may unfold with respect to the first keyboard section. As the second keyboard section rotates away from the first keyboard section, the first keyboard section slides in a second direction (which is opposite the first direction) along the length of the support plate. When the second keyboard section is co-planar with the first keyboard section, the first keyboard section has extended past an end of the support plate such that both keyboard sections center over the support plate.

In another embodiment, a keyboard assembly has a first keyboard section, a second keyboard section and a support plate section. All three sections may have about the same width and length. In this embodiment, the three sections may be completely detached from each other. In a first configuration, the first and second keyboard sections attach to form a full-size keyboard with the support plate section attached underneath the keyboard sections. In a second configuration, the three sections stack on top of each other to form a unitary body and a self-contained housing.

In one embodiment, the foldable keyboard assembly unfolds to a full size arrangement in the standard “QWERTY” layout. The keyboard may also conform to an ISO 9241-4:1998(E) standard (a copy of which is attached as Appendix A) for keyboards which is considered to be a full size keyboard having full-sized key tops (also referred to as full size keys). As such, the user does not need to familiarize himself to a different keyboard layout. The keyboard standard described by ISO 9241-4:1998(E) 6.2.1 calls for center-to-center key spacing (i.e., pitch) of 19 mm±1 mm. ISO 9241-4:1998(E) 6.2.3 calls for preferred key displacement between 2.0 mm and 4.0 mm.

In an alternative embodiment, the keys may have full-sized key tops whose center-to-center spacing (i.e., pitch) of adjacent alphabetical keys is approximately 18 to 19 mm horizontally (i.e., along the length of the keyboard assembly) and approximately 18 to 19 mm vertically. In one embodiment, both horizontal and vertical center-to-center spacing is approximately 18 mm.

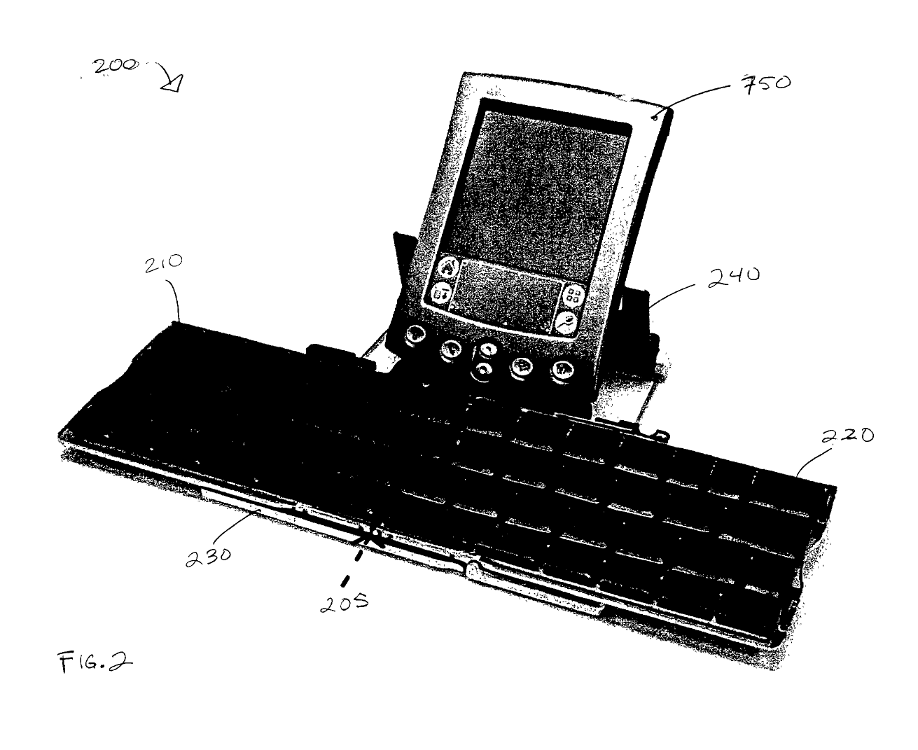

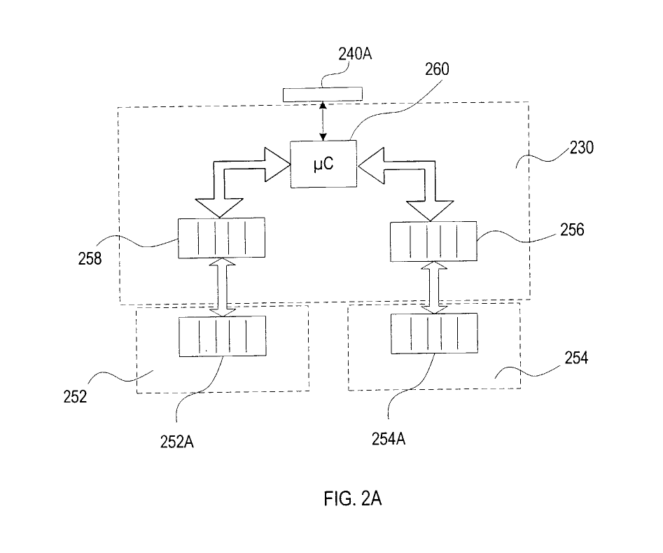

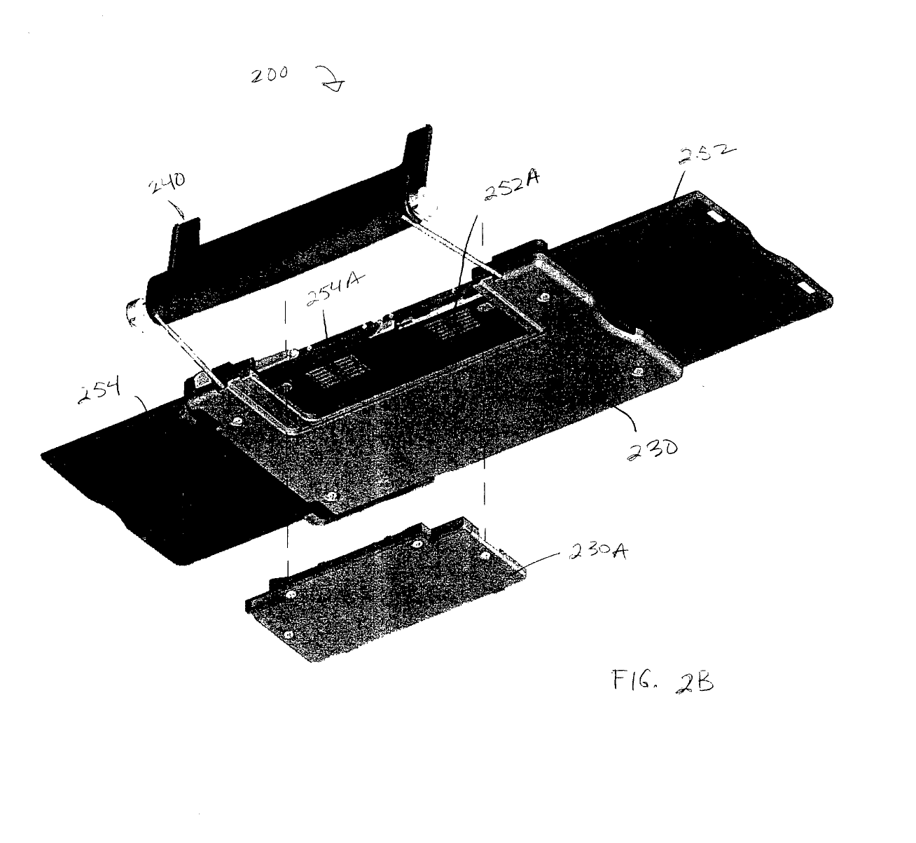

FIG. 2 illustrates a top perspective view of an embodiment of an unfolded keyboard assembly configured with a personal digital processing device. The keyboard assembly includes first keyboard assembly 210, second keyboard assembly 220, support plate 230, and connector 240. In one embodiment, the parts of the keyboard assembly are in continuous contact with each other. Division line 205 shows where first keyboard section 210 and second keyboard section 220 divide when the keyboard assembly folds.

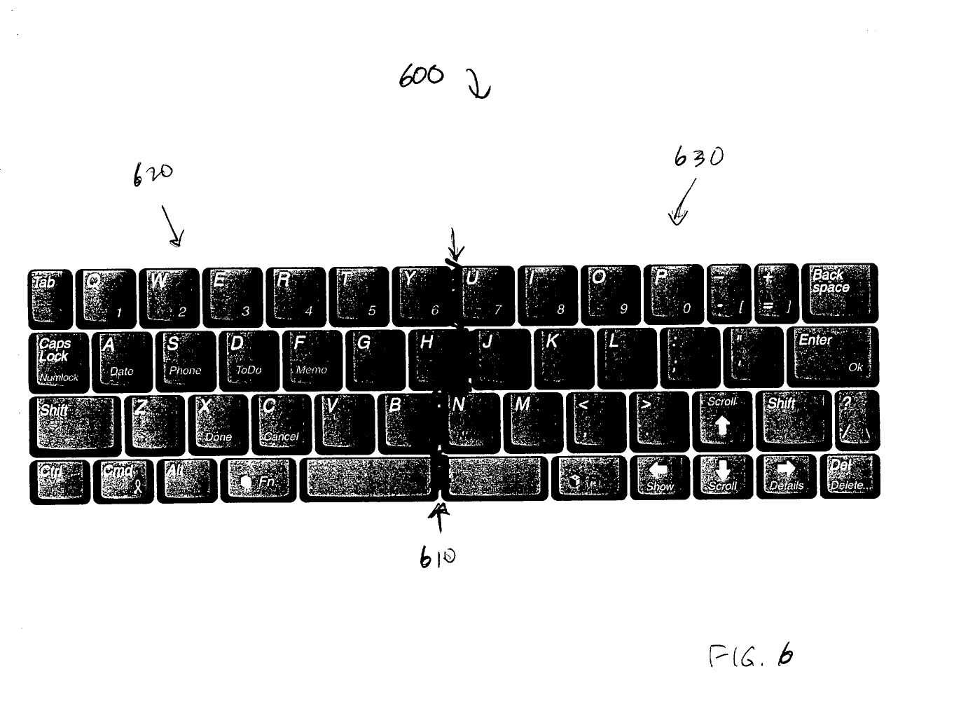

In one embodiment, keyboard sections unfold to a full-size, standard “QWERTY” layout. “QWERTY” is indicative of the keyboard layout in that the first six letters of the top row, in a direction from left to right, are Q-W-E-R-T-Y. The key tops of a keyswitch assembly comply with full size standards (e.g., about 18-19 mm center to center horizontal pitch, about 18-21 mm center to center vertical pitch, and a minimum horizontal strike surface width of about 12 mm). FIG. 6 illustrates one embodiment of standard QWERTY layout with a complete set of keys. The overall arrangement of the keys results in a rectangular layout. The keys corresponding to letters are about substantially the same size, while function keys (e.g., “Shift” and “Enter”) may be of varying sizes. Line 610 shows the jagged division separating first keyboard section 620 from second keyboard section 630. The division exists between the letters “Y” and “U,” “H” and “J,” “B” and “N”, and between the space bar.

Full-size keyboards allow the user to comfortably, privately, and quickly “touch-type.” They have a number of desirable features. Importantly, the keyswitches may be designed to provide sufficient “travel” (i.e., the distance the key moves when it is pressed), and tactile feedback (i.e., an over-center buckling action), that signals to the user that the key has been pressed sufficiently.

When users type quickly with all fingers, they often strike the keys off center. To prevent the keys from binding, high quality keyswitches use mechanisms that keep the key caps parallel to the base as they are pressed. This allows the keys to be struck on any portion of their surface and at non-perpendicular angles to the direction of depression. Co-pending U.S. patent application Ser. No. 09/738,000, filed Dec. 14, 2000, entitled “Keyswitch,” describes an example of a keyswitch assembly for use in keyboards. Co-pending U.S. patent application Ser. No. 09/737,015, filed Dec. 14, 2000, entitled “Spring,” describes an example of a spring for use in keyswitch assemblies. Both applications are hereby incorporated herein by reference. U.S. provisional application 60/359,585 entitled “Foldable Keyboard,” filed Feb. 25, 2002, is also incorporated herein by reference.

In a QWERTY layout, keyboard sections may not be divided evenly down the exact center of the unfolded keyboard. Nevertheless, first keyboard section 210 and second keyboard section 220 have substantially similar sizes, with substantially equal width, length, and thickness. Also, the support plate 230 has substantially the same width and length.

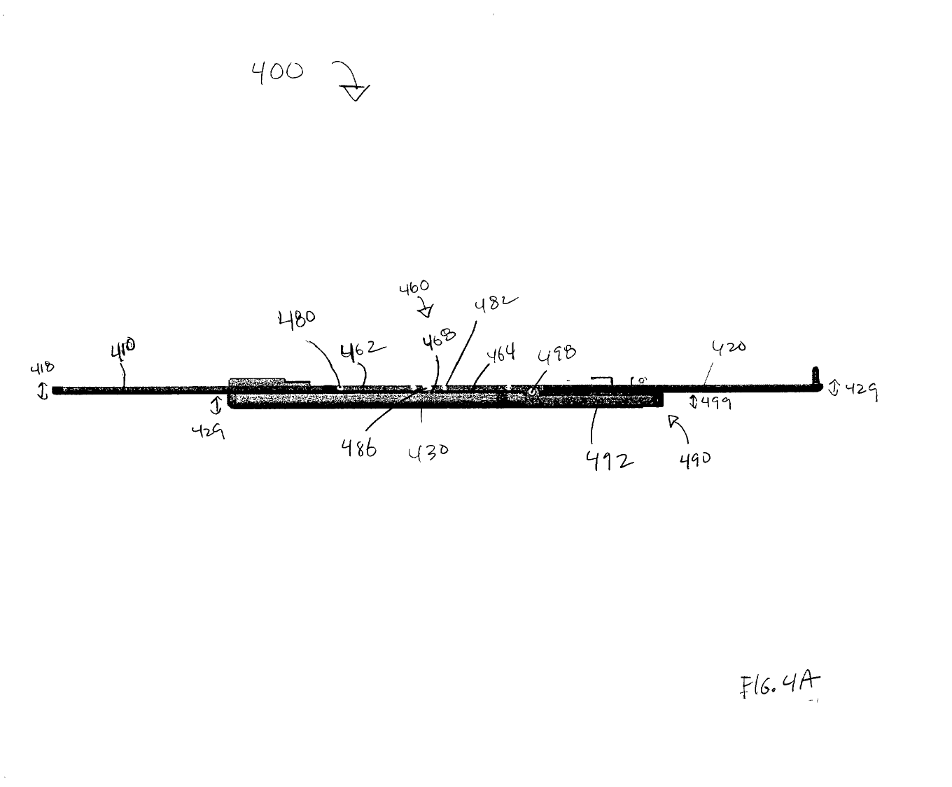

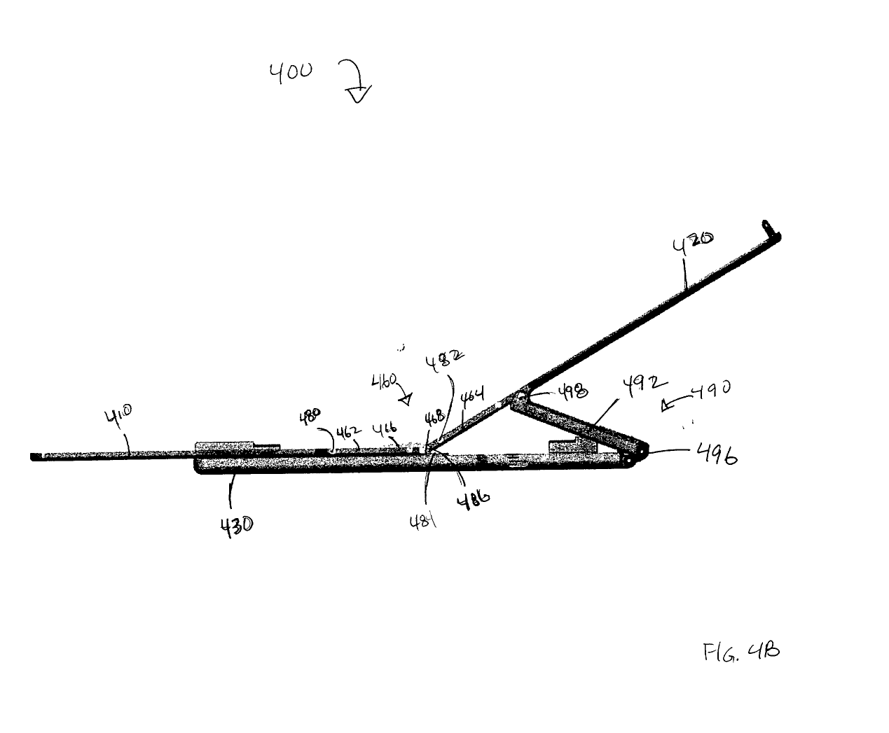

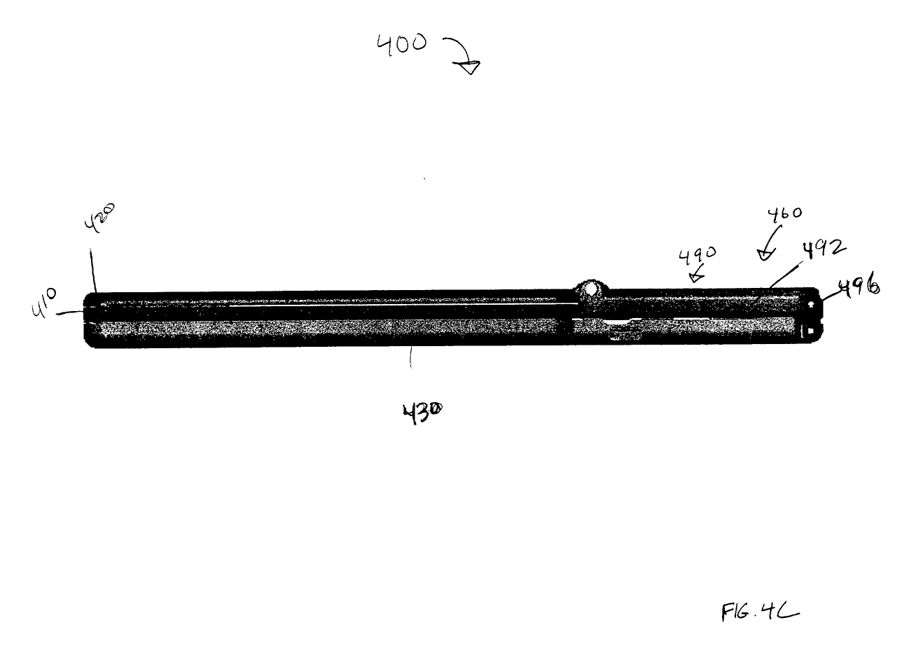

In one embodiment, support plate 230 may overlap first keyboard section 200 and second keyboard section 220 in the unfolded configuration. Support plate may also be substantially the same size as the two keyboard sections, with substantially equal width, length and thickness. In one embodiment the thickness of the two keyboard sections and the support plate may be in the range of about 2 mm to about 6 mm, although the support plate may be thicker than the two keyboard sections, such as is shown in the embodiment of FIG. 4B, and the keyboard sections may be thinner than about 2 mm. The lengths of the two keyboard sections and the support plate, in certain embodiments, may be in the range of about 6 cm to about 15 cm. As shown in FIG. 4C, the lengths of these three components may be virtually the same or substantially the same. The widths of the two keyboard sections and the support plate, in certain embodiments, may be in the range of about 4 cm to about 12 cm.

In a particular embodiment, the support plate or base plate 230 (which may house the CPU, battery, and other electrical components) has a thickness up to about 8 mm. Without the CPU, battery and other electrical components, the thickness may be up to about 5 mm. The keyboard sections 210, 220 (each section, when the keyboard is in a collapsed position) have a thickness of about 3 mm. Support plate or base plate 210 has a width of about 74 mm and a length of about 138 mm, and each keyboard section 210, 220 has a width of about 74 mm, and a length of about 138 mm. Support plate 230 does not extend across the entire length of the unfolded keyboard, but overlaps a portion of each keyboard section. In one embodiment, support plate 230 overlaps each keyboard section 210, 220 substantially equally. This configuration may provide the optimal configuration for a user to use all the keys of the unfolded keyboard comfortably. Support plate 230 aligns along a length of keyboard sections 210, 220 in the unfolded configuration. Support plate 230 is coupled to keyboard sections 210, 220 along the length of keyboard sections such that from a top view, support plate 230 is not visible.

In one embodiment, the keyboard assembly folds and unfolds in the following manner. In the unfolded, fully extended configuration (e.g., the configuration shown in FIGS. 2, 3A or 4A), support plate 230 overlaps equally first keyboard section 210 and second keyboard section 220, such that portions of first keyboard section 210 and second keyboard section 220 extend past the length of support plate 230. First keyboard section 210, second keyboard section 220 and support plate 230 may be in continuous contact with each other and are substantially similar in size. In addition, first keyboard section may be coupled to support plate 230 by sliding rails along at least a portion of the length of first keyboard section 210.

From the unfolded configuration, second keyboard section 220 folds or rotates toward first keyboard section 210. The folding region between first keyboard section 210 and second keyboard section 220 may be jagged division 205. During this motion, first keyboard section slides along support plate 230 towards an end of support plate 230 (e.g., towards the right side of support plate 230), such that first keyboard section 210 aligns over support plate 230 without any portion of first keyboard section extending past a length of support plate 230. Second keyboard section 220 aligns over first keyboard section 210 without any portion of second keyboard section 220 extending past a length of first keyboard section 210. As such, because first keyboard section 210, second keyboard section 220, and support plate 230 are of substantially equal size and shape, when folded, all three parts align over each other.

The mechanics of folding second keyboard section 220 and sliding first keyboard section 210 are, in one embodiment, tied together such that any distance second keyboard section 220 folds or rotates, first keyboard section 210 slides by a corresponding distance. This way, completely unfolding second keyboard section results in first keyboard section sliding along support plate 230 such that support plate 230 extends over first keyboard section 210 and second keyboard section 220 equally. Completely folding second keyboard section 220 over first keyboard section 210 results in first keyboard section 210, second keyboard section 220, and support plate 230 aligning over each other to give the appearance of a unitary body. Second keyboard section 220 may rotate up to 180 degrees with respect to first keyboard section 210 to change between a folded and unfolded keyboard configuration.

Thus, keyboard assembly 200 may be defined as having two main keyboard configurations. One main configuration is an unfolded, or open configuration in which the two keyboard sections are fully exposed, co-planar and coupled to each other to form a full-size QWERTY layout keyboard having full size key tops. Support plate 230 overlaps each keyboard section substantially evenly underneath the keyboard sections to provide a rigid base for keyboard use.

The other main keyboard configuration is the folded or closed configuration, in which one keyboard section folds with respect to each the other such that the keys (and hence the key tops of the keys) from each keyboard section oppose each other. First keyboard section 210, second keyboard section 220, and support plate 230 align on top of each other to form a unitary body. To make the folded keyboard sections as thin as possible, the keys may be fully depressed in the folded configuration (such that the keyswitches of each key are electrically shorted). In the folded configuration, a bottom surface of support plate 230 and a bottom surface of second keyboard section 220 form the exterior of a self-contained housing for the keyboard assembly. In the folded configuration, because none of the keys are exposed, the self-contained housing protects the keys of the keyboard sections. In addition, the footprint of the folded keyboard, in one embodiment, may be small enough to fit comfortably in a shirt pocket or in the palm of the user's hand for carrying from one location to another.

In one embodiment, connector 240 may be coupled to the keyboard assembly. Connector 240 provides for electrical connection between the keyboard and the personal processing device, such as a personal digital assistant (PDA). Electrical signals, such as key codes that identify keystrokes, may be sent from the keyboard to the personal processing device. Support plate 230 is coupled to connector 240. A personal processing device may be electrically and mechanically coupled to connector 240 in the unfolded configuration.

Two groups (first and second groups) of conductive strips may be fixed on the inner surface of support plate 230 (which faces the bottom sides of the keyboard sections in the unfolded configuration) and a first and a second corresponding group of conductive strips may be attached to the bottom side of the first and second keyboard sections respectively. An example of this arrangement is shown in FIG. 2A. In the unfolded configuration, the first corresponding group of conductive strips on the first keyboard section (e.g., strips 252A in FIG. 2A) electrically contacts the first group of conductive strips (e.g., strips 258) on the inner surface of support plate 230, thereby allowing for electrical connection of signals between the first keyboard section (e.g., section 252 of FIG. 2A) and a keyboard controller which scans the electrical matrix of keyswitches in each section, such as keyboard controller 260 shown in FIG. 2A.

Similarly, the second corresponding group of conductive strips (e.g., strips 254A of FIG. 2A) on the second keyboard section (e.g., section 254) electrically contacts the second group of conductive strips (e.g., strips 256) on the inner surface of support plate 230, thereby allowing for electrical connection of signals between the second keyboard section and the keyboard controller (e.g., controller 260 of FIG. 2A).

When the two keyboard sections are moved from the unfolded to the folded configuration these electrical connections are, in this embodiment, disconnected. The sets of conductive strips allow for the folding and unfolding without requiring a flexible electrical cable; however, in one alternative embodiment, a flexible electrical cable (which allows for the folding and unfolding) may connect each keyboard section to the keyboard controller (e.g., controller 260) which may be disposed on the support plate 230. The controller 260 is electrically coupled to electrical contactor 240A which is part of connector 240 and provides keystroke signals, identifying individual keys which have been depressed as a user types, to the connector 240 which in turn provides these signals to the PDA connected to the connector 240. It will be appreciated that the controller 260 may scan a conventional electrical matrix of keyswitches in the two keyboard sections in a conventional manner. It will also be appreciated that, in an alternative embodiment, the keyboard controller may be disposed in the PDA and may scan the electrical matrix of keyswitches through electrical contactor 240A.

FIG. 2B illustrates one embodiment of an arrangement of conductive strips in the unfolded configuration, viewed from the bottom side of keyboard assembly 200. First keyboard section 252 has conductive strips 252A disposed above and within an area of support plate 230. Second keyboard section 254 also has corresponding conductive strips 254A disposed above and within an area of support plate 230. Connector 240 is shown coupled to support plate 230, and in an extended position to support a PDA or similar device.

Support plate segment 230A is shown in an exploded view with respect to support plate 230. When part of support plate 230, support plate segment 230A overlaps conductive strips 252A of first keyboard section 252 and conductive strips 254A of second keyboard section 254. Conductive strips 256, 258, as well as keyboard controller 260 and connector 240A described with respect FIG. 2A, may be disposed on an inner surface (not shown) of support plate segment 230A. Conductive strips 256, 258 would align with conductive strips 254A, 252A, respectively, allowing for electrical connection of signals of first keyboard section 252 and second keyboard section 254 with keyboard controller 260. As described above, keyboard controller 260 is electrically coupled to electrical contactor 240A, which is part of connector 240, and provides keystroke signals, identifying individual keys that have been depressed as a user types, to the connector 240. Connector 240 in turn provides these signals to the PDA connected to the connector 240.

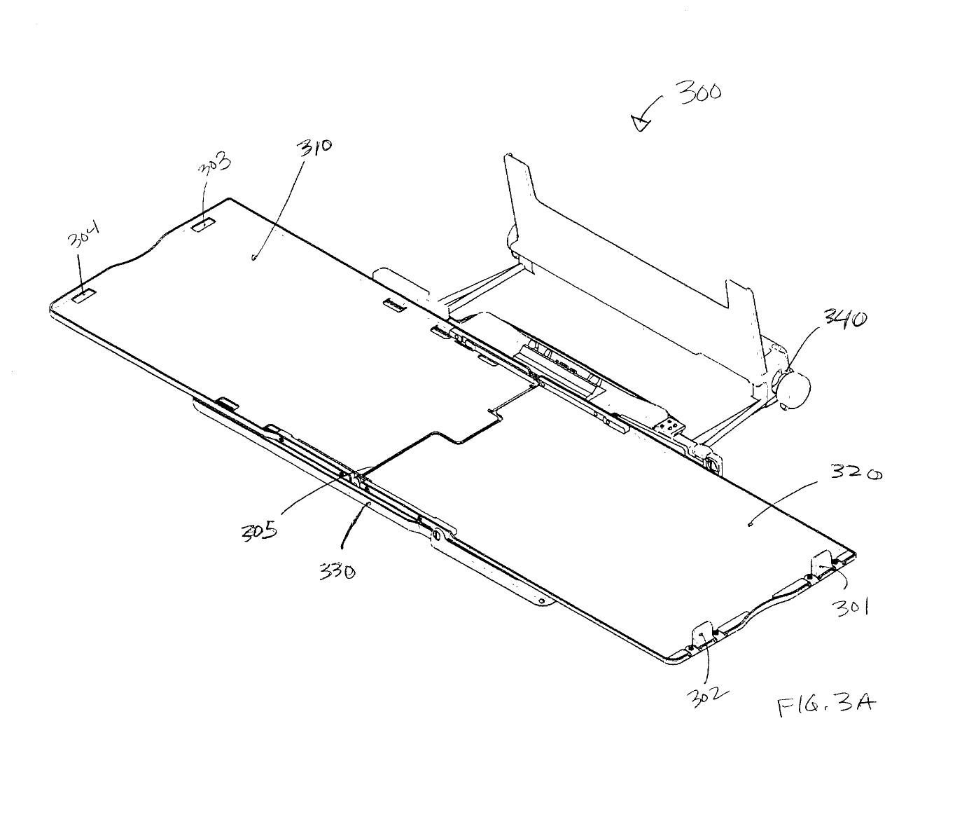

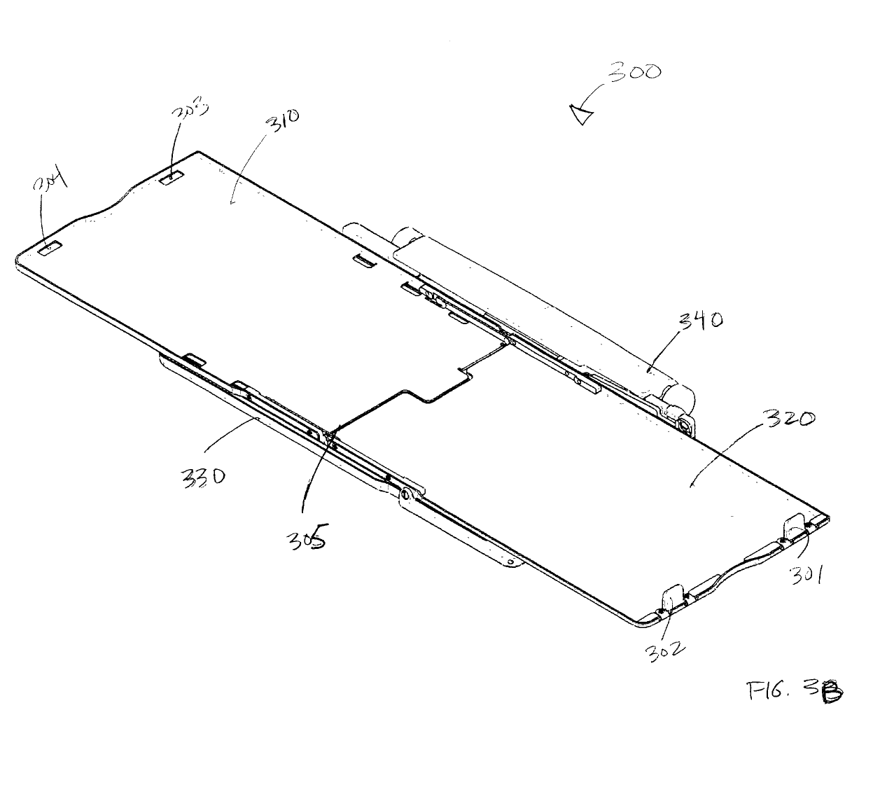

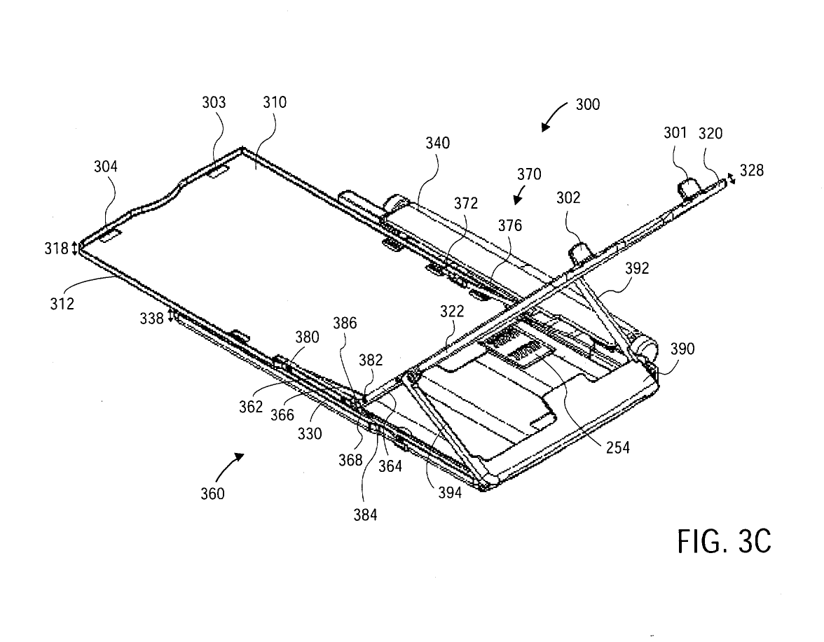

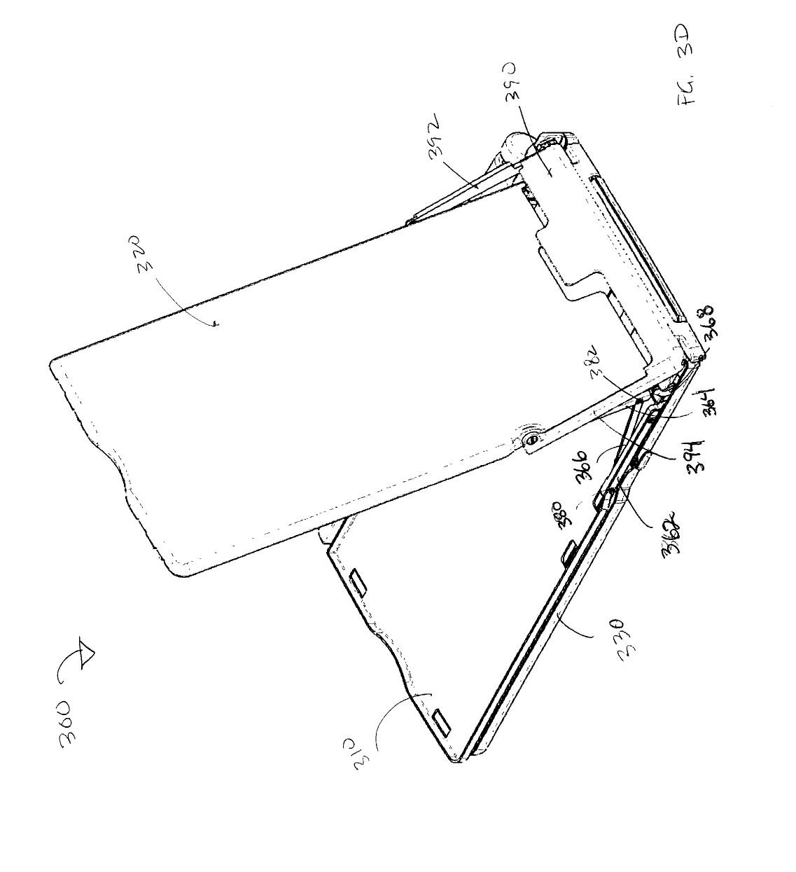

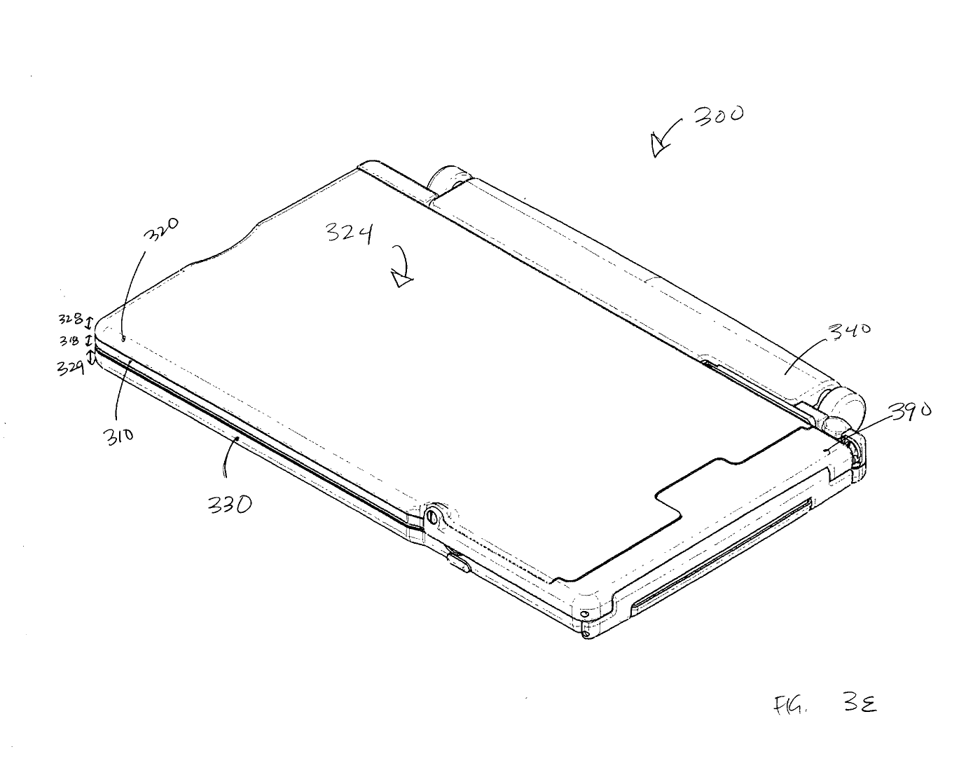

FIG. 3A illustrates one embodiment of a keyboard assembly in the unfolded configuration with a personal processing device connector in an extended configuration. In the unfolded configuration, keyboard assembly 300 has first keyboard section 310, second keyboard section 320, support plate 330 and connector 340. For clarity of description, keyboard sections 310, 320 are shown without the keys. It will be appreciated that these keys are supported on the surfaces of these two sections. First keyboard section 310 and second keyboard section 320 are divided along line 305. The division between the keyboard sections is not straight because a standard keyboard layout in QWERTY format has rows of keys staggered from one row to the next. Inserts 301, 302 may be disposed near an end of second keyboard section 320. Slots 303, 304 may be displaced on first keyboard section 310 that aligns with inserts 301, 302, in the folded configuration, such that the keyboard sections may be securely coupled together.

In one embodiment, first keyboard section 310, second keyboard section 320, and support plate 330 are substantially equal in size. Support plate 330 overlaps first keyboard section 310 and second keyboard section 320 equally. Because support plate 330 overlaps first and second keyboard sections substantially equally, the unfolded keyboard is supported firmly for comfortable use under a variety of surfaces. Support plate stabilizes the keyboard sections and allows a user to apply an amount of force consistent with the use of any standard-type keyboard. As such, the keyboard assembly provides the advantages of operating comparably to a full-size, unitary keyboard and the portability to use the keyboard under a variety of environments and circumstances.

Connector 340 allows the keyboard assembly to attach to a personal digital processor to register keystrokes. Connector 340 is coupled centrally to support plate 330 along a length of support plate 330 on the back side of plate 330 as shown in FIG. 3A. Connector 340 may have an extended configuration to secure a personal digital processor, and a closed configuration, as illustrated in FIG. 3B.

FIG. 3C illustrates a perspective view of foldable keyboard assembly 300 in an intermediate configuration that is neither completely folded nor unfolded. In this configuration, foldable keyboard sections 310, 320 are coupled to each other by linkage assembly 360. Linkage assembly 360 serves as the folding mechanism that allows keyboard sections 310, 320 to alternate from a folded configuration to an unfolded configuration. Linkage assembly includes first bar 362, second bar 364, third bar 366, and fourth bar 368. In an alternative embodiment, keyboard assembly 300 may also include second linkage assembly 370 disposed on a side opposite linkage assembly 360. Second linkage assembly 370 may also have first bar 372, second bar 374 (not shown), third bar 376, and fourth bar 378 (not shown). Second linkage assembly 370 may provide additional support and stability to the keyboard assembly, as well as facilitating the folding of the keyboard sections 310, 320. It may be appreciated that second linkage assembly 370 may not be required for keyboard sections 310, 320 to fold and unfold.

First keyboard section 310 has a thickness 318, second keyboard section 320 has a thickness 328, and support plate 330 has a thickness 338. In one embodiment, the thickness of all three parts are substantially equal. A layout of keys (not shown) on first keyboard section 310 and second keyboard section 320 may be compressed (i.e., travel) such that the overall thickness of the keyboard sections with the keys may be substantially the thickness of the keyboard sections.

First bar 362 of linkage assembly 360 is coupled to edge 312 of first keyboard section 310. First bar 362 is coupled along edge 312 near a point where first keyboard section 310 meets second keyboard section 320. For example, in FIG. 3A, division 305 between first keyboard section 310 and second keyboard section 320 is denoted being uneven (e.g., 305). Similarly, second bar 364 is coupled to edge 322 of second keyboard section 320. Third bar 366 is coupled to first bar 362 at first pivot 380, and to second bar 364 at second pivot 382. Fourth bar 368 also couples first bar 362 and second bar 364. One end of fourth bar 368 forms a third pivot with first bar 362 and the other end of fourth bar 368 forms a fourth pivot with second bar 364.

The mechanics of the folding and unfolding of keyboard assembly 300 was described generally above. As will be described in greater detail below, first pivot 380 and second pivot 382 allow keyboard sections 310, 320 to fold and unfold with respect to each other. Third pivot 384 and fourth pivot 386 allow first keyboard section 310 to slide along support plate 330 when keyboard assembly 300 changes from an unfolded configuration to a folded configuration. Thus, the four pivots 380, 382, 384, 386 operate cooperatively to allow the simultaneous folding and unfolding of second keyboard section 320, and sliding of first keyboard section 310.

Optionally, keyboard assembly 300 may include brace 390 to support second keyboard section 320. Arms 392, 394 coupled to edges 322, 324 (note: 324 not shown) of second keyboard section 320 provide rigid support as second keyboard section rotates from a folded to an unfolded configuration. However, it may be appreciated that brace 390 is not essential to allow the folding or sliding of keyboard assembly 300.

Keyboard assembly 300 illustrated in FIG. 3C also shows conductive strip 256 disposed on support plate 330. As described with respect to FIGS. 2A, 2B, conductive strip 256 makes contact with a corresponding conductive strip (e.g., conductive strip 254A) disposed on second keyboard section 320. The connection between the two conductive strips allows for electrical connection of signals between second keyboard section 320 and a keyboard controller (e.g., controller 260 from FIGS. 2A, 2B).

FIGS. 3B-3E illustrate one embodiment showing the range of motion of a keyboard assembly changing from a fully extended, unfolded configuration to a completely folded configuration. Turning now to FIG. 3B, keyboard assembly 300 is illustrated in a fully unfolded configuration with first keyboard section 310 and second keyboard section 320 co-planar with respect to each other, and support plate 330 disposed underneath the keyboard sections and overlapping the keyboard sections 310, 320 equally. First keyboard section 310 and second keyboard section 320 each has top surface 314, 324 respectively for a distribution of keys. The keyboard sections also have a bottom section (not shown) that is generally smooth and rigid. The bottom surface of first keyboard section 310 allows it to slide along support plate 330 and the bottom surface of second keyboard section 320 becomes one side of a self-contained housing when keyboard assembly 300 is in the folded configuration.

In this configuration, linkage assembly 360 has first bar 362, second bar 364, and third bar 366 substantially parallel with each other and substantially parallel to the plane of the keyboard sections. Fourth bar 368 (not shown) maintains a low position such that it stays within a height of first bar 362 and second bar 364. As such, pivots 380, 382, 384, and 386 (not viewable) are substantially parallel to each other. Optionally, linkage assembly 300 may have second linkage assembly 370 described above. With respect to key assemblies (not shown) on the keyboard sections, linkage assembly 360 may be at a height lower than the height of the keycaps, such that none of the linkage assembly bars, including the pivots, interfere with the pressing of keys, when in the unfolded configuration.

FIG. 3C illustrates keyboard assembly 300 in a partially folded configuration. Here, rotating second keyboard section 320 on pivots 384, 386 of fourth bar 368 pulls first keyboard section 310 towards second keyboard section 320 by rotating pivot 382 of third bar 366 coupled to second bar 364. Because third bar 366 is also coupled to first bar 362, first keyboard section 310 slides along support plate 330. In this configuration, pivot 382 moves such that it is raised above first arm 360 and pivot 380.

Thus, a rotational force applied to second keyboard section 320 to fold over first keyboard section 310 corresponds to a horizontal force on first keyboard section 310. First keyboard section 310 slides along rails (not shown) on support plate 330. In this configuration, because second keyboard section 320 is only approximately 25% folded, first keyboard section 310 still extends past support plate 330. Alternatively, this keyboard configuration may be one in which the keyboard is approximately 75% unfolded. In addition, applying a horizontal force on first keyboard section 310 towards second keyboard section 320 may cause second keyboard section 320 to fold toward first keyboard section 310. Thus, the motions of folding and unfolding of keyboard assembly 300 are inter-related.

FIG. 3D illustrates keyboard assembly 300 in another intermediate folded configuration. Depending on one's perspective, keyboard assembly 300 may be seen as either partially open or nearly folded. In this configuration, first keyboard section 310 extends marginally past support plate 330 because keyboard assembly 300 is closer to the folded configuration than the fully extended, unfolded configuration. As mentioned above, first keyboard section 310 is able to slide along support plate 330 because first keyboard 310 engages rails (not shown) on support plate 330. It should be noted that the movement of first keyboard section 310 may be accomplished by means other than engaging rails on support plate 330.

The movement of first keyboard section 310 along support plate 330 as illustrated from FIG. 3C to FIG. 3D shows that first keyboard section 310 has a width that is approximately the same width as support plate 330. Second keyboard section 320 also has approximately the same width as first keyboard section 310 and support plate 330. One end of second keyboard section 320 has an indented configuration corresponding to the uneven division between first keyboard section 310 and second keyboard section 320. The layout of keys in a standard QWERTY layout does not make for a division of the keyboard down the middle. Tab portion 396 of brace 390 integrates with indented portion 321 of second keyboard section 320. This way, when second keyboard section 320 lies flat over first keyboard section 310, the exposed surface of second keyboard section 320 appears smooth and seamless with brace 390.

FIG. 3E illustrates keyboard assembly 300 in a completely folded configuration. In this perspective view, top side 324 of second keyboard section 320 is seen with first keyboard section 310 disposed between second keyboard section 320 and support plate 330. Brace 390 integrates with second keyboard section 320 such that top surface 324 appears to mate seamlessly with second keyboard section 320. This folded keyboard configuration may be one embodiment of a compact form keyboard assembly 300 may take.

In the completely folded configuration, keys (not shown) of first keyboard section 310 and second keyboard section 320 may face each other and be fully compressed, thereby minimizing the thickness of each keyboard section 310, 320. When the keys are fully depressed, the overall thickness of each keyboard section 310, 320 may be approximately the thickness 318, 328 of each keyboard section only. By having the keys compress as much as possible, the overall size of keyboard assembly 300 in the folded configuration may be minimized. In an alternative embodiment, the thickness of keyboard sections 310, 320 may be approximately half the thickness 329 of support plate 330. As such, in the folded configuration, the combined thickness of the keyboard sections 318, 328 is substantially the same as thickness 329 of support plate 330.

FIGS. 4A-4C illustrate a side view of keyboard assembly 400 changing from an unfolded configuration to a folded configuration. FIGS. 4A shows keyboard assembly 400 in an unfolded configuration. First keyboard section 410 and second keyboard section 420 are generally co-planar with respect to each other and appear to integrate continuously with each other to form a full-size keyboard. In one embodiment, the full-size keyboard conforms to a QWERTY layout. Linkage 460 couples first keyboard section 410 and second keyboard section 420 to each other, as well as acting as the pivot region for second keyboard section 420 to fold with respect to the first keyboard section 410. Bar 468 of linkage assembly 460 shows the general location of the pivot region. In this unfolded configuration, pivots 480, 482, and 486 are visible. Pivot 484 is obstructed from view by support plate 430. First keyboard section 410 and second keyboard section 420 are generally similar in length and thickness.

Both keyboard sections 410, 420 are coupled to support plate 430. Support plate 430 is generally flat and rigid, and has a thickness 429 that is generally similar to the keyboard sections. In addition, support plate 430 has a length that is generally similar to each keyboard section 410, 420. As shown, support plate 430 couples to the keyboard sections 410, 420 simultaneously, and is disposed near a substantially center portion of the overall length of the first and second keyboard sections 410, 420. Because first keyboard section 410 and second keyboard section 420 are similar in length, it is not possible for support plate to extend across the entire length of both keyboard sections. As such, support plate 430 overlaps each keyboard section 410, 420 equally to provide a rigid and balanced support to keyboard assembly 400.

First arm 492 of brace 490 couples to support plate 430 along a horizontal edge of support plate 430. First arm 492 has thickness 499 substantially equal to the thickness 429 of support plate 430 so as not to add any additional thickness to support plate 430. First arm 492 of brace 490 extends from an end of support plate 430 to pivot 498.

FIG. 4B shows keyboard assembly 400 in an intermediate configuration in which keyboard assembly 400 is partially folded. As second keyboard section 420 is raised above support plate 430, brace 490 pivots at pivot ends 496, 498. First arm 492 pivots upwards from pivot end 496 of support plate 430 and at pivot end 498 where brace 490 is coupled to second keyboard section 420. Linkage assembly 460 with pivots 480, 482, 484, 486 that couple first keyboard section 410 and second keyboard section 420 has shifted horizontally along a length of support plate 430 towards pivot end 496. A portion of first keyboard section 410 still extends past support plate 430 at an end opposite pivot end 496.

The configuration of keyboard assembly 400 in FIG. 4B also shows the movement of four-bar linkage assembly 460. First bar 462 is coupled to an edge of first keyboard section 410 and second bar 464 is coupled to an edge of second keyboard section 420. Third bar 466 is coupled to first bar 462 at pivot 480 and to second bar 464 at pivot 482. Fourth bar 468 is also coupled to first bar 462 at pivot 484 (not visible) and to second bar 464 at pivot 486. The four pivots formed by linkage assembly 460 allow first keyboard section 410 to slide along support plate 430 while second keyboard section 420 folds over first keyboard section 410.

As second keyboard section 420 is raised above support plate 430, third bar 466 is raised such that pivot 482 is at a height above first keyboard section 410. Pivot 482 behaves as a moving pivot that arcs toward first bar 462. In the unfolded configuration as illustrated in FIG. 4A, pivot 482 is substantially co-planar with first bar 462 and pivot 480.

FIG. 4C illustrates keyboard assembly 400 in the folded configuration. Second keyboard assembly 420 rests on top of first keyboard assembly 410, keyboard sections 410, 420 together rest on support plate 430. In the folded configuration, the key cap surface (not shown) of keyboard sections 410, 420 oppose each other. Bottom surface 424 of second keyboard section 420 and bottom surface 434 of support plate 430 form the exterior surfaces of folded keyboard assembly 400. Bottom surfaces 424, 434 may be made of a hard, plastic or metallic material. As such, keyboard assembly 400 in the folded configuration forms a self-contained housing for keyboard sections 410, 420. The keys remain protected allowing keyboard assembly 400 to be truly portable without the potential of the keys becoming damaged.

The keyboard assembly in the folded configuration also maintains a very low profile. First keyboard section 410 and second keyboard section 420 have a combined thickness that is substantially equal to the thickness of support plate 430. In addition, keyboard sections 410, 420 and support plate 430 have substantially equal lengths, giving the folded keyboard the appearance of a rectangular unitary body.

Linkage assembly 460 region connecting first keyboard section 410 and second keyboard 420 has shifted near pivot end 496. In the folded configuration, linkage assembly 460 is not visible, having been disposed behind arm 492 of brace 490.

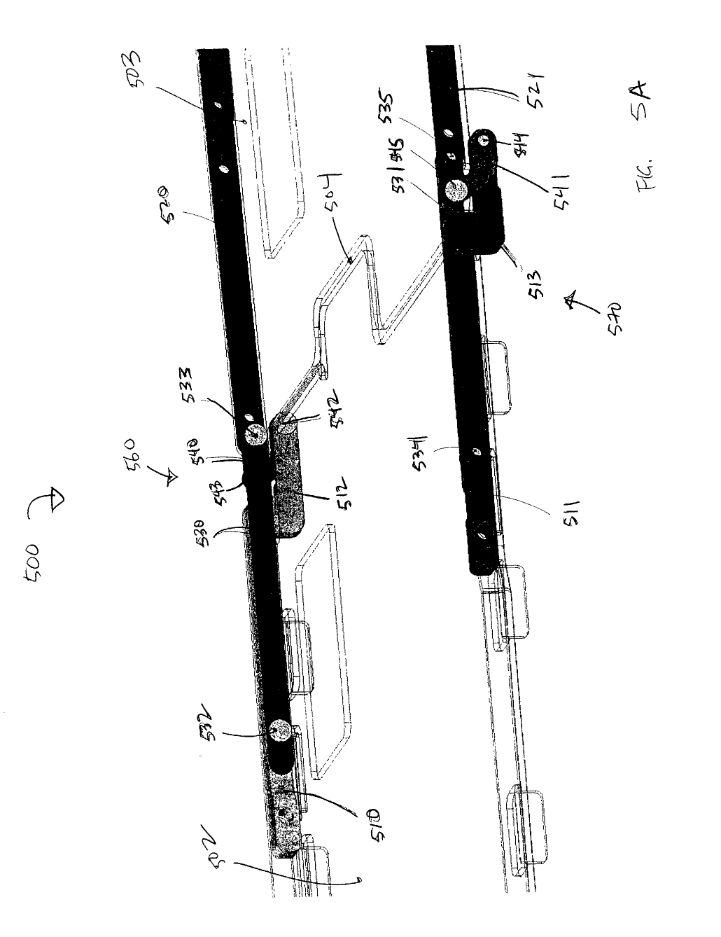

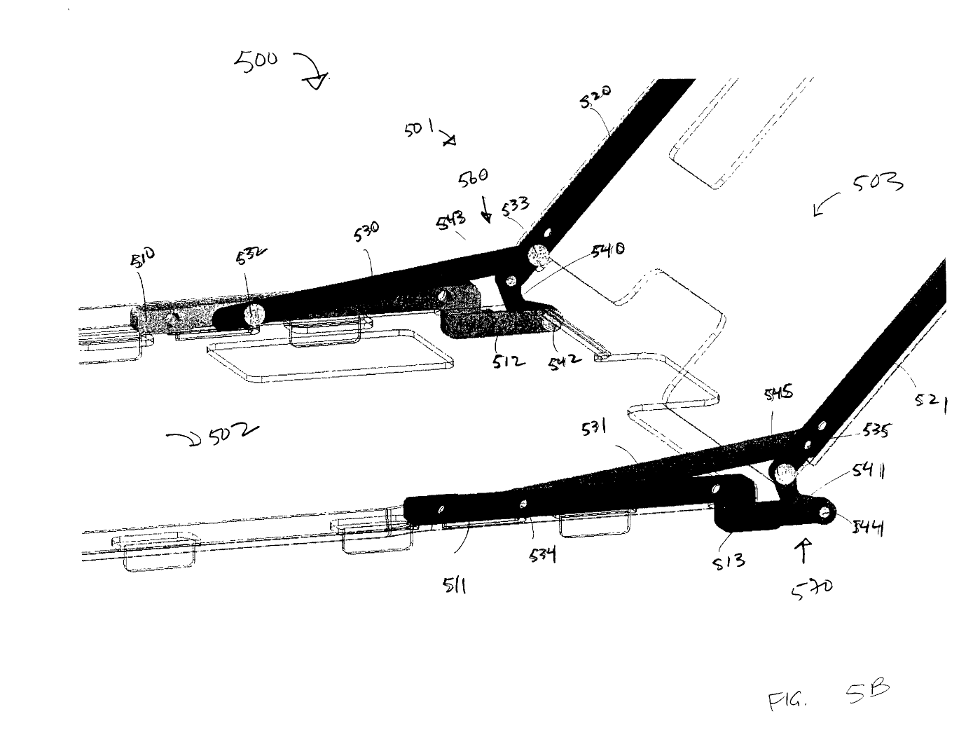

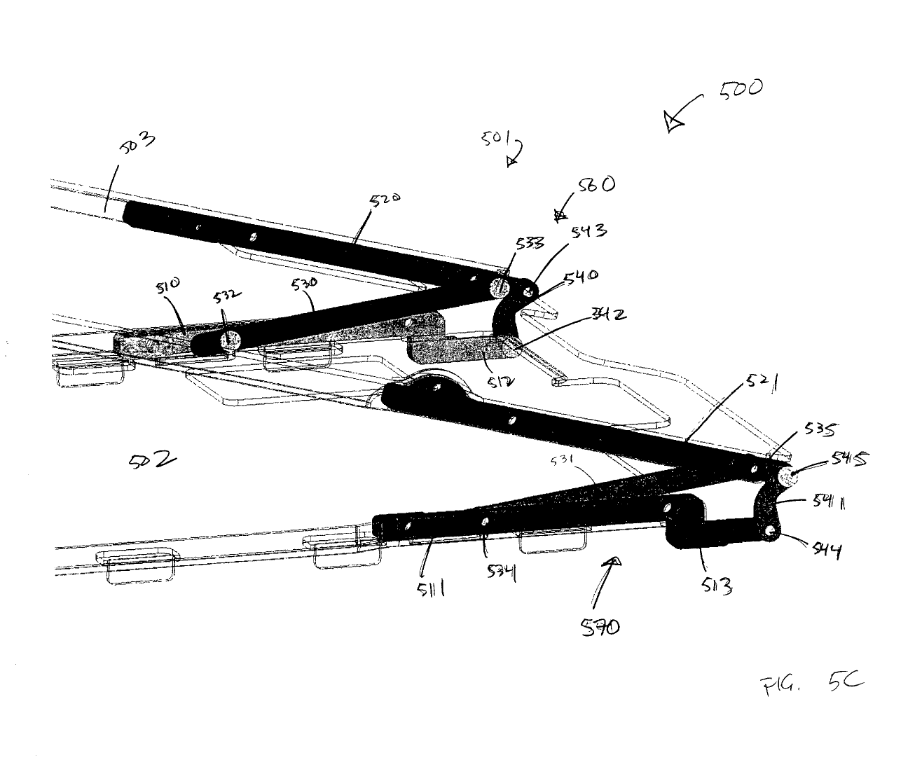

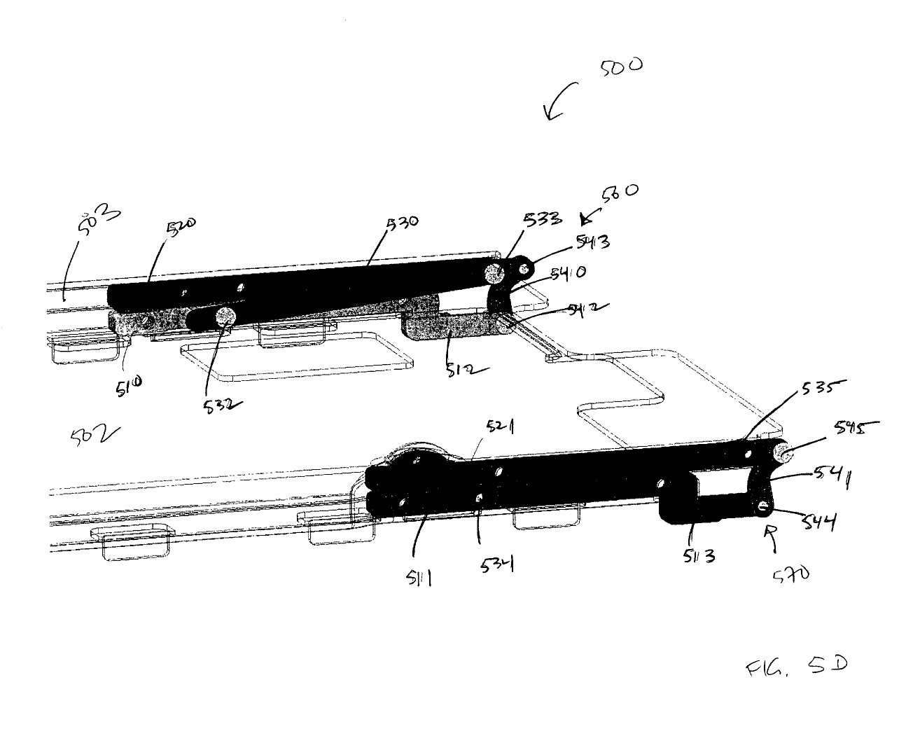

FIGS. 5A-5D illustrate perspective views of one embodiment of a linkage assemblies 560, 570 that enable keyboard assembly 501 to change from an unfolded configuration to a folded configuration. For clarity of description and understanding, linkage assemblies 560, 570 are illustrated without the corresponding keyboard sections. However, description of linkage assemblies 560, 570 may be considered with respect to the description above relating to the folding and unfolding of the keyboard sections, in particular, with respect to FIGS. 3A-3E and FIGS. 4A-4C.

The illustration in FIG. 5A shows the configuration of linkage assemblies 560, 570 corresponding to an unfolded keyboard configuration. Linkage assembly 560, coupled near one side of a keyboard assembly, is a four-bar linkage having first bar 510, second bar 520, third bar 530, and fourth bar 540. Alternatively, second four-bar linkage 570 may be disposed near the opposite side of linkage assembly 560. Second four-bar linkage 570 includes first bar 511, second bar 521, third bar 531, and fourth bar 541.

First bar 510 is coupled to first keyboard section 502 along a horizontal edge of first keyboard section 502. First bar 510 has arm portion 512 that extends towards second keyboard section 503 at a height below the longer elongated portion of first bar 510. As will be described in greater detail below, first bar 510 is configured with arm portion 512 to enable fourth bar 540 to pivot such that in the folded configuration, second keyboard section 503 may rest evenly on first keyboard section 502.

Second bar 520 is coupled to the second keyboard section 503 along a horizontal edge of second keyboard section 503. In the unfolded keyboard configuration, first bar 510 and second bar 520 are substantially co-planar. First bar 510 and second bar 520 have a length that may be shorter than the length of each keyboard section 502, 503, and as such, do not extend along the entire length of both keyboard sections 502, 503. First bar 510 and second bar 520 are disposed near division 504 between first keyboard section 502 and second keyboard section 503.

First bar 510 and second bar 520 may not be directly coupled together; alternatively, they may be coupled together through third bar 530. Third bar 530 is coupled to first bar 530 at pivot 532 and to second bar 520 at pivot 533. First bar 510 and second bar 520 is also coupled through fourth bar 540. Fourth bar 540 is coupled to arm portion 512 of first bar 510 at pivot 542, and to second bar at pivot 543. Fourth bar 540 is a short segment that is slightly bent from pivot 542 to pivot 543.

As noted above, keyboard assembly 501 may also have a second linkage assembly 570. Although not necessary to enable keyboard assembly 501 from folding and unfolding, second linkage assembly 570 provides added support and stability. Second linkage assembly 570 has corresponding four-bar linkage 511, 521, 531, 541 with corresponding pivots 534, 535, 544, 545 as described for linkage 560.

Linkage assemblies 560, 570 illustrated in FIG. 5B correspond to keyboard assembly 501 in a partially folded configuration. The change in configurations of the four-bar linkage assemblies 560, 570 and corresponding pivots 532, 533, 542, 543, 534, 535, 545, 544 may be compared to linkage assemblies 560, 570 in the unfolded configuration of FIG. 5A, to show the mechanics of linkage assemblies 560, 570. As second keyboard section 503 is raised and rotated towards first keyboard section 502, pivot 533 rotates with respect to pivot 532 from its relatively co-planar configuration with second bar 520 and first bar 510. Pivot 543 rotates with respect to pivot 542. Thus, pivots 533 and 543 act as moving pivots while pivots 532 and 542 remain stationary. The linkage assemblies 560, 570 operate such that when keyboard assembly 501 changes from an unfolded configuration to a folded configuration, moving pivots 533 and 543 rotate in opposite directions. Pivot 533 moves towards first bar 510 while pivot 543 moves away from first bar 510.

FIG. 5C shows linkage assemblies 560, 570 in a position with first keyboard section 502 and second keyboard section 503 in a nearly closed configuration. Second bar 520 has rotated nearly 180 degrees towards first bar 510.

FIG. 5D shows linkage assemblies 560, 570 in a configuration that corresponds to a completely folded keyboard assembly with second keyboard section 503 rotated over first keyboard section 502. Second bar 520 rests on first bar substantially parallel to each other. Second bar 520, pivot 533, and pivot 543 are generally along the same plane. Third bar 530 spans diagonally across both first bar 510 and second bar 520 from pivot 532 to pivot 533.

Linkage assemblies 560, 570 illustrated in FIG. 5D correspond to a folded keyboard configuration. Linkage assembly 560 has four bars 510, 520, 530, 540. In one embodiment, second linkage assembly 570 may be disposed on an opposite side of linkage assembly 560. Second linkage assembly 570 has four bars 512, 522, 532, 540 and pivots 534, 535, 544, 545.

Of course, the present invention can alternatively be embodied in non-QWERTY layouts such as key layouts designed for a special purpose devices, including workstations, information devices, cellular telephones, or software packages. While the present invention can be embodied in a full-size or standard size keyboard having a 19-mm pitch between keys, a reduced size keyboard can also embody the present invention, i.e. a scaled-down version of the foldable keyboard is contemplated.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A keyboard assembly, comprising:
a first keyboard section and a second keyboard section, the first keyboard section and the second keyboard section foldable with respect to each other between a folded configuration and an unfolded configuration; and
a support plate coupled to at least one of the keyboard sections, wherein the first and second keyboard sections and the support plate have approximately a same width and length, the unfolded configuration having the first keyboard section and the second keyboard section substantially coplanar with respect to each other, and the support plate aligned under the first and second keyboard sections.

2. The keyboard assembly of claim 1, wherein the folded configuration has first keyboard section, second keyboard section and support plate aligned on top of each other to form a self-contained housing, and the support plate is integrally coupled to the at least one of the keyboard sections.

3. The keyboard assembly of claim 1, wherein the first and second keyboard sections comprise keys and wherein the keys are not exposed when in the folded configuration.

4. The keyboard assembly of claim 2, wherein the first and second keyboard sections and the support plate align with each other to form a unitary body in the folded configuration.

5. The keyboard assembly of claim 1, wherein the unfolded configuration has the first keyboard section and the second keyboard section centered substantially over the support plate.

6. The keyboard assembly of claim 1, wherein the first keyboard section aligns along the length of the support plate when in the folded configuration.

7. The keyboard assembly of claim 1, wherein the first keyboard section and the second keyboard section, when in the unfolded configuration, conforms with an ISO 9241-4:1998(E) standard layout for keyboards.

8. The keyboard assembly of claim 1, wherein the first keyboard section slides in response to rotation of the second keyboard section as the second keyboard section is folded.

9. A keyboard assembly, comprising:
a first keyboard section and a second keyboard section; and
at least one linkage assembly coupled to the first keyboard section and the second keyboard section, the at least one linkage assembly to enable the keyboard sections to alternate between a folded configuration and an unfolded configuration, the at least one linkage assembly comprising:
a first bar coupled to the first keyboard section along a length of the first keyboard section near a region where the first keyboard section meets the second keyboard section in the unfolded configuration;
a second bar coupled to the second keyboard section along a length of the second keyboard section near a region where the second keyboard section meets the first keyboard section in the unfolded configuration;
a third bar coupled to the first bar and the second bar; the third bar having a first pivot coupled to the first bar and a second pivot coupled to the second bar, the second pivot to move along a rotating arc of the first pivot; and
a fourth bar coupled to the first bar and the second bar, the fourth bar having a third pivot coupled to the first bar and a fourth pivot coupled to the second bar.

10. The keyboard assembly of claim 9, wherein the first keyboard section and the second keyboard section each comprises:
a top side and a substantially flat backside; and
a set of keycaps disposed on the top side, wherein the unfolded configuration has the first, second, third and fourth pivots generally at a height below the keycaps.

11. The keyboard assembly of claim 10, wherein the folded configuration has second pivot at a height above the keycaps of the first keyboard section.

12. The keyboard assembly of claim 10, wherein the second pivot to rotate up to 180 degrees along the rotating arc of the first pivot.

13. The keyboard assembly of claim 9, wherein a rigid support plate slideably couples to the backside of the first keyboard section, the rigid support plate and the second keyboard section to form an exterior of a self-contained housing for the keyboard assembly in the folded configuration.

14. The keyboard assembly of claim 9, wherein the first and second keyboard sections comprise keys and wherein the keys are not exposed in the folded configuration.

15. The keyboard assembly of claim 9, wherein the unfolded configuration conforms with an ISO 9241-4:1998(E) standard layout for keyboards.

16. The keyboard assembly of claim 9, wherein the unfolded configuration has first keyboard section and the second keyboard section substantially coplanar.

17. The keyboard assembly of claim 9, wherein linkage assembly operates to slide the first keyboard section in response to rotation of the second keyboard section.

18. The keyboard assembly of claim 9, wherein the first and second keyboard sections comprise keys having a center to center spacing of at least approximately 18 mm.

19. A keyboard assembly, comprising:
a first keyboard section and a second keyboard section;
a support plate slideably coupled to the first keyboard section; and
at least one linkage assembly coupling the first keyboard section to the second keyboard section, the linkage assembly to enable the first and second keyboard sections to alternate between a folded configuration and an unfolded configuration, wherein the folding or unfolding of the second keyboard section with respect to the first keyboard section slides the first keyboard section along the support plate, and wherein the sliding of the first keyboard section along the support plate folds or unfolds the second keyboard section with respect to the first keyboard section.

20. A keyboard assembly of claim 19, wherein the at least one linkage assembly comprises:
a first bar coupled to the first keyboard section along a length of the first keyboard section near a region where the first keyboard section meets the second keyboard section in the unfolded configuration;
a second bar coupled to the second keyboard section along a length of the second keyboard section near a region where the second keyboard section meets the first keyboard section in the unfolded configuration;
a third bar coupled to the first bar and the second bar; the third bar having a first pivot coupled to the first bar and a second pivot coupled to the second bar, the second pivot to move along a rotating arc of the first pivot; and
a fourth bar coupled to the first bar and the second bar, the fourth bar having a third pivot coupled to the first bar and a fourth pivot coupled to the second bar.

21. The keyboard assembly of claim 19, wherein the folded configuration has first keyboard section, second keyboard section and support plate aligned on top of each other to form a self-contained housing.

22. The keyboard assembly of claim 19, wherein the first and second keyboard sections comprise keys and wherein the keys are not exposed when in the folded configuration.

23. The keyboard assembly of claim 19, wherein the unfolded configuration has the first keyboard section and the second keyboard section centered substantially over the support plate.

24. The keyboard assembly of claim 19, wherein the unfolded configuration conforms with an ISO 9241-4:1998(E) standard layout for keyboards.

25. The keyboard assembly of claim 19, wherein the at least one linkage assembly operates to slide the first keyboard section in response to rotation of the second keyboard section.

26. A keyboard assembly, comprising:
a first keyboard section and a second keyboard section;
a pivot point disposed between the first keyboard section and the second keyboard section, the pivot point to enable the second keyboard section to rotate between a folded and unfolded configuration with respect to the first keyboard section; and
a support plate slideably coupled to the first keyboard section, wherein when the second keyboard section rotates about the pivot point, the first keyboard section slides along the support plate and the pivot point simultaneously slides in a direction of the first keyboard section.

27. The keyboard assembly of claim 26, wherein the unfolded configuration has the first keyboard section and the second keyboard section centered substantially over the support plate.

28. The keyboard assembly of claim 27, wherein the first keyboard section and the second keyboard section have key sets that conform with an ISO 9241-4:1998(E) standard layout for keyboards, and the key tops of the key sets are full size.

29. The keyboard assembly of claim 28, wherein the pivot point is at a height below the key sets of the first and second keyboard sections.

30. The keyboard assembly of claim 26, wherein the folded configuration has a key set of the first keyboard section that opposes a key set of the second keyboard section.

31. The keyboard assembly of claim 30, wherein the pivot point is at a height above the key set of the first keyboard section.

32. The keyboard assembly of claim 30, wherein the key set of the first and second keyboard sections are not exposed.

33. The keyboard assembly of claim 32, wherein the folded configuration forms a self-contained housing.

34. A keyboard assembly, comprising:
a first keyboard section and a second keyboard section;
a support plate slideably coupled to the first keyboard section; and
means for coupling the first keyboard section to the second keyboard section with a linkage assembly, the linkage assembly to enable the first and second keyboard sections to alternate between a folded configuration and an unfolded configuration, wherein the folding or unfolding of the second keyboard section with respect to the first keyboard section slides the first keyboard section along the support plate, and wherein the sliding of the first keyboard section along the support plate folds or unfolds the second keyboard section with respect to the first keyboard section.

35. The keyboard assembly of claim 34, further comprising means aligning the first keyboard section, the second keyboard section, and the support plate with each other to form a unitary body in the folded configuration.

36. The keyboard assembly of claim 34, further comprising means for centering the first keyboard section and the second keyboard section over the support plate in the unfolded configuration.

37. A keyboard assembly, comprising:
a first keyboard section and a second keyboard section;
a pivot point disposed between the first keyboard section and the second keyboard section, the pivot point to enable the second keyboard section to rotate between a folded and unfolded configuration with respect to the first keyboard section; and
means for slideably coupling a support plate to the first keyboard section, wherein when the second keyboard section rotates about the pivot point, the first keyboard section slides along the support plate and the pivot point simultaneously slides in a direction of the first keyboard section.

38. The keyboard assembly of claim 37, further comprising means aligning the first keyboard section, the second keyboard section, and the support plate with each other to form a unitary body in the folded configuration.

39. The keyboard assembly of claim 37, further comprising means for centering the first keyboard section and the second keyboard section over the support plate in the unfolded configuration.
